(19) United States
(12) Patent Application Publication
(10) Pub. No.: US 2009/0040169 A1
(43) Pub. Date: Feb. 12, 2009

(54) DRIVING MODULE FOR DRIVING LCD PANEL AND METHOD OF FORMING LCD DEVICE

(76) Inventor: Yu-Jui Chang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/834,692

(22) Filed: Aug. 7, 2007

(51) Int. Cl. G09G 3/36

(52) U.S. Cl. 345/101

(57) ABSTRACT

The present invention discloses a driving module for driving an LCD panel and a method of forming an LCD device. The driving module includes: a source driving circuit, for driving the LCD panel; and a heat sink module, coupled to the source driving circuit and integrated with the LCD panel, for dissipating heat generated from the source driving circuit. The method of forming an LCD device including: utilizing a specific semiconductor process to form a LCD panel; and forming a heat sink module integrated with the LCD panel during the specific semiconductor process.

### BACKGROUND OF THE INVENTION

1. Field of the Invention

The present invention relates to a driving module for driving an LCD panel and a method of forming an LCD device, and more particularly, to a driving module having a heat sink module integrated with an LCD panel and a method of forming the heat sink module integrated with the LCD panel.

2. Description of the Prior Art

Nowadays, the LCD panel is tended to have a larger size and a higher frame rate. However, when the size of the LCD panel becomes larger or the frame rate of the LCD panel becomes higher, it will require more charges for charging and discharging the LCD panel. Since the charges is only provided by a source driver for driving the LCD panel, thus the charges passing through the source driver will become more. The above condition will result in a higher power passing through the source driver, and the source driver will have a higher temperature. Therefore, an efficient and economical solution for reducing the temperature of the source driver is eagerly required.

### SUMMARY OF THE INVENTION

It is therefore one of the objectives of the present invention to provide a driving module having a heat sink module integrated with an LCD panel and a method of forming the heat sink module integrated with the LCD panel to solve the above problems.

According to an embodiment of the present invention, a driving module for driving an LCD panel is disclosed. The driving module includes: a source driving circuit, for driving the LCD panel; and a heat sink module, coupled to the source driving circuit and integrated with the LCD panel, for dissipating heat generated from the source driving circuit.

According to an embodiment of the present invention, a method of forming an LCD device is disclosed. The method of forming an LCD device includes: utilizing a specific semiconductor process to form a LCD panel; and forming a heat sink module integrated with the LCD panel during the specific semiconductor process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified diagram of a driving module for driving an LCD panel according to an embodiment of the present invention.

FIG. 2 is a flow chart showing an exemplary method for forming an LCD device with a heat sink function according to an embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

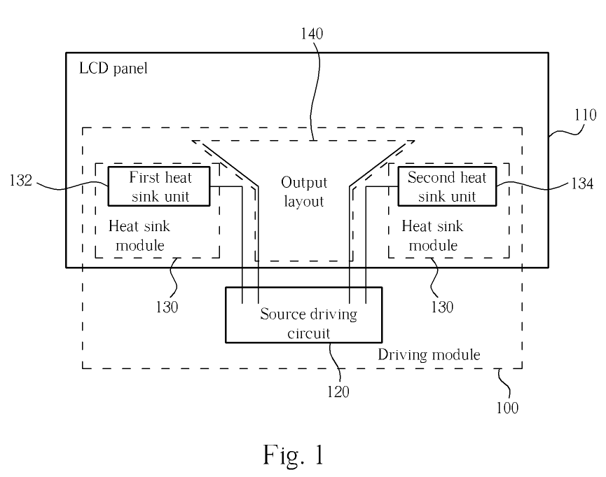

Please refer to FIG. 1. FIG. 1 shows a simplified diagram of a driving module 100 for driving an LCD panel 110 according to an embodiment of the present invention. As shown in FIG. 1, the driving module 100 includes a source driving circuit 120 and a heat sink module 130. The source driving circuit is utilized for driving the LCD panel 110 and the heat sink module 130 is coupled to the source driving circuit 120 and integrated with the LCD panel 110 and utilized for dissipating heat generated from the source driving circuit 120, wherein the heat sink module 130 is positioned in an area without the output layout 140 of the source driving circuit 120 on the LCD panel 110. In this embodiment, the heat sink module 130 includes a first heat sink unit 132 and a second heat sink unit 134, wherein the first heat sink unit 132 is directly connected to a power line (not shown) of the source driving circuit 120, and the second heat sink unit 134 is directly connected to a ground line (not shown) of the source driving circuit 120. However, this embodiment mentioned above is only for illustrative purposes, but is not a limitation of the present invention. In addition, please note that the heat sink module 130 is made of conductive material that is also used in manufacturing the LCD panel 110, such as transparent electrode or ITO, and the heat sink module 130 is formed while manufacturing the LCD panel 110.

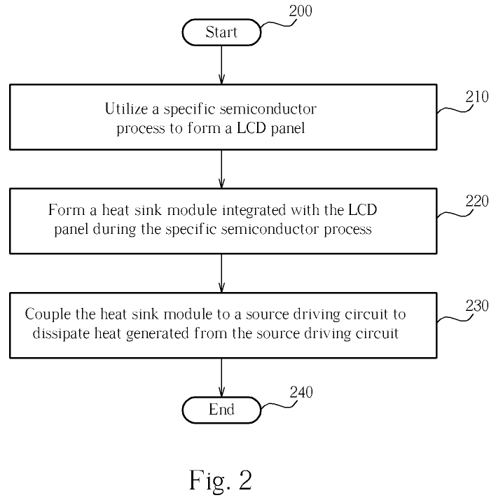

Please refer to FIG. 2. FIG. 2 is a flow chart showing an exemplary method for forming an LCD device with a heat sink function according to an embodiment of the present invention. Provided that substantially the same result is achieved, the steps of the process flow chart need not be in the exact order shown and need not be contiguous, that is, other steps can be intermediate. The method for forming an LCD device with a heat sink function includes the following steps:

Step 200: Start.

Step 210: Utilize a specific semiconductor process to form a LCD panel.

Step 220: Form a heat sink module integrated with the LCD panel during the specific semiconductor process.

Step 230: Couple the heat sink module to a source driving circuit to dissipate heat generated from the source driving circuit.

Step 240: End.

Please note that the step 230 can include directly connecting the heat sink module to a power line and a ground line of the source driving circuit. However, this embodiment mentioned above is only for illustrative purposes, but is not a limitation of the present invention.

Briefly summarized, the present invention offers an efficient and economical solution for designing and manufacturing a LCD device with a heat sink function, wherein a driving module for driving an LCD panel in the LCD device has a heat sink module integrated with the LCD panel.

Those skilled in the art will readily observe that numerous modifications and alterations of the device and method may be made while retaining the teachings of the invention.

What is claimed is:

1. A driving module for driving an LCD panel, the driving module comprising:
a source driving circuit, for driving the LCD panel; and
a heat sink module, coupled to the source driving circuit and integrated with the LCD panel, for dissipating heat generated from the source driving circuit.

2. The driving module of claim 1, wherein the heat sink module is made of conductive material that is also used in manufacturing the LCD panel.

3. The driving module of claim 1, wherein the heat sink module is made of transparent electrode.

4. The driving module of claim 1, wherein the heat sink module is made of ITO.

5. The driving module of claim 1, wherein the heat sink module is formed while manufacturing the LCD panel.

6. The driving module of claim 1, wherein the heat sink module is coupled to a power line of the source driving circuit.

7. The driving module of claim 1, wherein the heat sink module is coupled to a ground line of the source driving circuit.

8. The driving module of claim 1, wherein the heat sink module is directly connected to an input node of the source driving circuit.

9. The driving module of claim 8, wherein the input node is utilized for receiving a reference voltage level.

10. A method of forming an LCD device, comprising:
utilizing a specific semiconductor process to form a LCD panel; and
forming a heat sink module integrated with the LCD panel during the specific semiconductor process.

11. The method of claim 10, further comprising:
coupling the heat sink module to a source driving circuit to dissipate heat generated from the source driving circuit.

12. The method of claim 11, wherein the step of coupling the heat sink module to the source driving circuit comprises:
coupling the heat sink module to a power line of the source driving circuit.

13. The method of claim 12, wherein the step of coupling the heat sink module to the source driving circuit comprises:
coupling the heat sink module to a ground line of the source driving circuit.

14. The method of claim 12, wherein the step of coupling the heat sink module to the source driving circuit comprises:
directly connecting the heat sink module to an input node of the source driving circuit.

15. The method of claim 14, wherein the input node is utilized for receiving a reference voltage level.

16. The driving module of claim 10, wherein the heat sink module is made of conductive material that is also used in manufacturing the LCD panel.

17. The driving module of claim 10, wherein the heat sink module is made of transparent electrode.

18. The driving module of claim 10, wherein the heat sink module is made of ITO.

19. The driving module of claim 10, wherein the heat sink module is formed while manufacturing the LCD panel.
